(19) United States
(12) Patent Application Publication
(10) Pub. No.: US 2004/0209025 A1
(43) Pub. Date: Oct. 21, 2004

(54) Cold-shrinkable type rubber sleeve and method of manufacturing the same

(75) Inventors: Shozo Kobayashi, Chiyoda-ku (JP); Isao Takaoka, Chiyoda-ku (JP)

Correspondence Address: FURUKAWA ELECTRIC NORTH AMERICA, INC., 1940 DUKE ST, SUITE 200, ALEXANDRIA, VA, 22314, US

(73) Assignee: The Furukawa Electric Co., Ltd., Chiyoda-ku (JP)

(21) Appl. No.: 10/824,502

(22) Filed: Apr. 15, 2004

(30) Foreign Application Priority Data
Apr. 18, 2003 (JP) 2003-114751

(51) Int. Cl. B32B 1/08

(52) U.S. Cl. 428/34.9; 428/36.91

(57) ABSTRACT

A cold-shrinkable type rubber sleeve includes an internal semiconductive layer made of a rubber material, a reinforced insulation layer, an external semiconductive layer, and a stress-relief cone at each end of the reinforced insulation layer, and two edge-cut sections. Each edge-cut section is prepared near each of the stress-relief cones by edge-cutting the external semiconductive layer in a direction of a length of the cold-shrinkable type rubber sleeve. The internal semiconductive layer, the reinforced insulation layer, the external semiconductive layer, and the stress-relief cones are molded into one piece that is cylindrical.

### BACKGROUND OF THE INVENTION

1) Field of the Invention

The present invention relates to a cold-shrinkable type rubber sleeve that is used for an insulation joint (IJ) of power cables such as high-voltage CV cables.

2) Description of the Related Art

There are various kinds of structures for insulation joints for high-voltage CV cables. Such structures include an extrusion molded type, a pre-fabricated type, a tape wrapping molded type, and a tape wrapping type. In addition, a one-piece joint that has an excellent assembility and uses a cold-shrinkable type rubber sleeve has become available and been spreading recently with remarkable improvements in rubber molding technology.

A typical cold-shrinkable type rubber sleeve is shown in FIG. 3. The cold-shrinkable type rubber sleeve includes an internal semiconductive layer 1, a reinforced insulation layer 3, an external semiconductive layer 5, and stress-relief cones 7 at both ends of the reinforced insulation layer 3. An edge-cut section (shielding section) 9 is prepared at an end 8 of the cold-shrinkable type rubber sleeve by edge-cutting a part of the external semiconductive layer 5 in the direction of the length of the cold-shrinkable type rubber sleeve. Each part is formed mainly with rubber material. The internal semiconductive layer 1, the reinforced insulation layer 3, the external semiconductive layer 5, and the stress-relief cones 7 are molded into one piece that is substantially cylindrical.

The stress-relief cone 7 at other end 18 of the cold-shrinkable type rubber sleeve is attached to one end of the external semiconductive layer 5 to form one piece.

The cold-shrinkable type rubber sleeve is tube shaped and is elastic. The cold-shrinkable type rubber sleeve is molded to have a smaller internal diameter than an external diameter of a cable joint part (not shown). The internal diameter of the cold-shrinkable type rubber sleeve is kept expanded with a disassemble carrier pipe (not shown) set inside the cold-shrinkable type rubber sleeve. When an insulation joint is to be formed, at an assembly site, the cold-shrinkable type rubber sleeve is installed on the cable joint part by setting the cold-shrinkable type rubber sleeve so as to cover the cable joint part, and then disassembling and removing the carrier pipe so that the internal diameter of the cold-shrinkable type rubber sleeve shrinks. As a result, the cold-shrinkable type rubber sleeve makes an intimate contact with the cable joint part. Such a technology is disclosed in paragraphs 0018 to 0025 in the detailed description of the present invention clause and FIGS. 1 to 4 of Japanese Patent Application Laid Open No. 2000-324643.

However, the typical cold-shrinkable type rubber sleeve has the edge-cut section 9 only at the end 8; therefore, the form of the external semiconductive layer 5 that is molded on the periphery of the reinforced insulation layer 3 becomes complex. This is because a part of the external semiconductive layer 5 near the edge-cut section 9 becomes thin, and a part 2 of the external semiconductive layer 5 becomes thick.

Consequently, when the external semiconductive layer 5 is molded by injecting a semiconductive rubber material into a mold, an unbalance in the flowing speed of the injected rubber material is created in the mold because of presence of the parts in which the rubber material does not flow well. Because of such unbalance, the control of the molding pressure to the rubber material becomes complicated. In other words, the formation of the external semiconductive layer 5 requires more work, and fluctuation of the thickness of the external semiconductive layer 5 may arise.

Furthermore, because the part 2 of the external semiconductive layer 5 is thick and takes more time to cure than the part near the edge-cut section 9, the time required for curing the external semiconductive layer 5 itself becomes long. Consequently, there is an increase in the manufacturing cost and degradation of the quality.

It is an object of the present invention to provide a cold-shrinkable type rubber sleeve that is convenient to use, cheap, and easy to form.

### SUMMARY OF THE INVENTION

A cold-shrinkable type rubber sleeve according to an aspect of the present invention is tube shaped and includes an internal semiconductive layer that includes an elastic material and a semiconductive material; a reinforced insulation layer that is formed around the internal semiconductive layer to reinforce the internal semiconductive layer; an external semiconductive layer that includes an elastic material and a semiconductive material, and is formed around the reinforced insulation layer; and two stress-relief cones, wherein one stress-relief cone is formed at each end of the cold-shrinkable type rubber sleeve, and the external semiconductive layer is insulated from both the stress-relief cones.

A cold-shrinkable type rubber sleeve according to another aspect of the present invention is tube shaped and includes an internal semiconductive layer that includes an elastic material and a semiconductive material; a reinforced insulation layer that is formed around the internal semiconductive layer to reinforce the internal semiconductive layer; an external semiconductive layer that includes an elastic material and a semiconductive material, and is formed around the reinforced insulation layer; two stress-relief cones, wherein one stress-relief cone is formed at each end of the cold-shrinkable type rubber sleeve; and two edge-cut sections, each edge-cut section is formed near each of the stress-relief cones by edge-cutting the external semiconductive layer in a direction of a length of the cold-shrinkable type rubber sleeve.

A method of manufacturing a cold-shrinkable type rubber sleeve according to another aspect of the present invention includes forming a tube of an internal semiconductive layer with an elastic material and a semiconductive material; forming a reinforced insulation layer around the internal semiconductive layer to reinforce the internal semiconductive layer; forming an external semiconductive layer around the reinforced insulation layer with an elastic material and a semiconductive material; and forming a stress-relief cone at each end of the cold-shrinkable type rubber sleeve; and insulating the external semiconductive layer from both the stress-relief cones.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-section of a cold-shrinkable type rubber sleeve according to an embodiment of the present invention;

FIG. 2 is to explain a method of manufacturing of the cold-shrinkable type rubber sleeve according to the embodiment; and

FIG. 3 is a cross-section of a typical cold-shrinkable type rubber sleeve.

### DETAILED DESCRIPTION

Exemplary embodiments of a cold-shrinkable type rubber sleeve according to the present invention are explained in detail with reference to the accompanying drawings. In the drawings, like reference characters refer to like parts throughout.

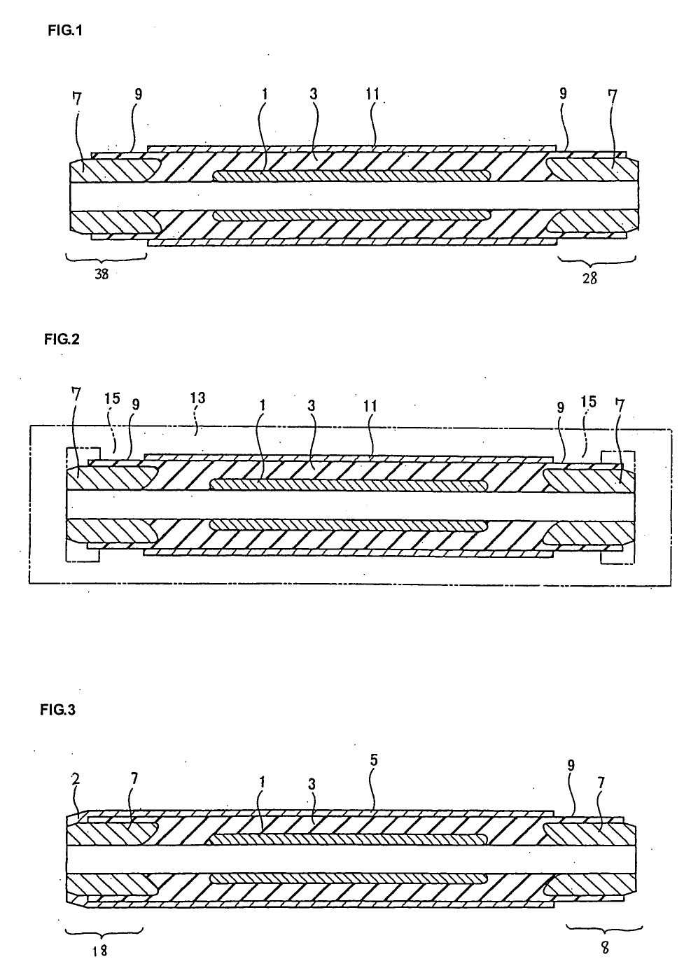

FIG. 1 is a cross-section of a cold-shrinkable type rubber sleeve according to an embodiment of the present invention. FIG. 2 is to explain a method of manufacturing of the cold-shrinkable type rubber sleeve according to the embodiment.

The cold-shrinkable type rubber sleeve of the present invention includes an internal semiconductive layer 1, a reinforced insulation layer 3, an external semiconductive layer 11, and a stress-relief cone 7 at each end of the reinforced insulation layer 3, and edge-cut sections 9. Each edge-cut section 9 is prepared at each of ends 28, 38 in the direction of the length of the cold-shrinkable type rubber sleeve by edge-cutting the external semiconductive layer 11. Each part is formed mainly with rubber material such as Ethylene-Propylene Rubber (EPR) and Silicone Rubber (SR). The internal semiconductive layer 1, the reinforced insulation layer 3, the external semiconductive layer 11, and the stress-relief cones 7s are molded into one piece that is substantially cylindrical.

The reinforced insulation layer 3 is formed to have a substantially cylindrical structure by molding the rubber material. The internal semiconductive layer 1 is formed inside the tube-shaped structure of the reinforced insulation layer 3 by molding a semiconductive rubber material that contains carbon and the like. The internal semiconductive layer 1 is embedded in such a manner that an inner surface of the internal semiconductive layer 1 is exposed in the middle in length of the reinforced layer 3. The external semiconductive layer 11 is formed thinly around the reinforced insulation layer 3 in a substantially cylindrical shape by molding a semiconductive rubber material that contains carbon and the like. The stress-relief cone 7 is formed at each end of the reinforced insulation layer 3 in a substantially cylindrical shape by molding a semiconductive rubber material that contains carbon and the like. The edge-cut section 9 is prepared at each of the ends 28, 38 by edge-cutting the external semiconductive layer 5 in the direction of the length of the cold-shrinkable type rubber sleeve.

By preparing the edge-cut section at each of the ends 28, 38, the form of the external semiconductive layer 11 becomes simple. In other words, the external semiconductive layer 11 becomes thin and has a uniform thickness. Consequently, the molding pressure to the rubber material can be controlled easily, and the external semiconductive layer 11 can be formed more easily. Therefore, the fluctuation of the thickness of the external semiconductive layer 11 is less likely to occur. Moreover, the external semiconductive layer 11 cures in short time.

The cold-shrinkable type rubber sleeve is elastic. The cold-shrinkable type rubber sleeve is molded to have a smaller internal diameter than an external diameter of a cable joint part (not shown). The internal diameter of the cold-shrinkable type rubber sleeve is kept expanded with a disassemble carrier pipe (not shown) set inside the cold-shrinkable type rubber sleeve. For example, the cold-shrinkable type rubber sleeve having 60 millimeter (mm) of the internal diameter and 600 mm of the external diameter is kept expanded to have 150 mm of the internal diameter with the carrier pipe. When an insulation joint is to be formed, at an assembly site, the cold-shrinkable type rubber sleeve is installed over the cable joint part by setting the cold-shrinkable type rubber sleeve so as to cover the cable joint part, and then disassembling and removing the carrier pipe. The elasticity of the cold-shrinkable type rubber sleeve realizes a fit between the cold-shrinkable type rubber sleeve and the cable joint part.

One example of manufacturing the cold-shrinkable type rubber sleeve is explained below. The internal semiconductive layer 1 and the stress-relief cones 7 are molded in advance with molds and mandrels specially prepared for each part.

Then, the reinforced insulation layer is molded with a mold and the mandrel. In the middle of the mandrel, the internal semiconductive layer 1, which has been molded in advance, is installed. The stress-relief cones 7, which have been molded in advance, are installed, to the mandrel, keeping a predetermined space from each other. The reinforced insulation layer 3 is formed so as to cover the internal semiconductive layer and both the stress-relief cones 7.

Then, while molding the external semiconductive layer 11, the core of the cold-shrinkable type rubber sleeve, which has been molded, is kept in a mold for the external semiconductive layer 11 with the mandrel, or with a replaced mandrel that is specially prepared for the external semiconductive layer 11. The external semiconductive layer 11 is molded around the reinforced insulation layer 3 to have the edge-cut section 9 at each of the ends 28, 38. Care is taken that the semiconductive rubber material does not coat the periphery of the stress-relief cones 7 while molding the external semiconductive layer 11. It is preferable to prepare, for example, ring-shaped stoppers 15 that stick out toward the inside of the tube structure of the cold-shrinkable type rubber sleeve in each part that the edge-cut section 9 is placed in the mold 13 as shown with a dash-dotted line in FIG. 2.

The external semiconductive layer 11 according to the embodiment of the present invention is structurally insulated from the stress-relief cones 7. However, the external semiconductive layer 11 and one of the stress-relief cones 7 can be made conductive by wrapping a semiconductive tape.

Thus, a cold-shrinkable type rubber sleeve that is tube shaped according to the embodiment of the present invention includes an internal semiconductive layer that is mainly formed with rubber material, a reinforced insulation layer, an external semiconductive layer, a stress-relief cone at each end of the cold-shrinkable type rubber sleeve, and an edge-cut section that is formed near each of the stress-relief cones by edge-cutting the external semiconductive layer in the direction of the length of the cold-shrinkable type rubber sleeve. Because the edge-cut section is prepared near each of the stress-relief cones, the external semiconductive layer can be formed cylindrically around the reinforced insulation layer thinly and uniformly in thickness, consequently, the form of the external semiconductive layer is simplified.

Therefore, when the external semiconductive layer is molded around the reinforced insulation layer by injecting a semiconductive rubber material into a mold, the flowing speed of a semiconductive rubber material can be kept uniform and the semiconductive rubber material flows well in the mold. Moreover, the control of the pressure to the semiconductive rubber material is simple. As result, the external semiconductive layer can be formed with ease, and a fluctuation of the thickness of the external semiconductive layer is less likely to occur.

Furthermore, because the external semiconductive layer is thin, the external semiconductive layer uniformly cures in a shorter time regardless of parts. Therefore, the cold-shrinkable type rubber sleeve itself can be manufactured in a short time and with better quality. In addition, the short manufacturing time leads to the lower manufacturing cost.

Moreover, the cold-shrinkable type rubber sleeve according to the embodiment of the present invention has an advantage in such a case that cables having different diameters are connected. An insulation joint for such the cables requires the cold-shrinkable type rubber sleeve to be modified suitably to the condition of a cable joint part, as designated by a user, in a cable inserting direction to the cold-shrinkable type rubber sleeve and a position of the edge-cut section. Because the cold-shrinkable type rubber sleeve according to the embodiment of the present invention has the edge-cut section near each of the stress-relief cones, it is not necessary to prepare a newly modified cold-shrinkable type rubber sleeve that satisfies the designation of the user. Therefore, it is possible to save extra works and improve the assembility in forming the insulation joint.

Furthermore, because the external semiconductive layer sufficiently covers the stress-relief cones, the electric filed does not leak and no partial electric discharge takes place.

Moreover, because the form of the external semiconductive layer is substantially cylindrical, the form of a mold to manufacture the external semiconductive layer can be simplified. As a result, the manufacturing cost can be lowered and the formability improves.

Furthermore, because the thickness of the external semiconductive layer is uniform, a semiconductive rubber material flows uniformly in the mold, thus, the formation of the external semiconductive layer improves.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A cold-shrinkable type rubber sleeve that is tube shaped, comprising:
an internal semiconductive layer that includes an elastic material and a semiconductive material;
a reinforced insulation layer that is formed around the internal semiconductive layer to reinforce the internal semiconductive layer;
an external semiconductive layer that includes an elastic material and a semiconductive material, and is formed around the reinforced insulation layer; and
two stress-relief cones, wherein one stress-relief cone is formed at each end of the cold-shrinkable type rubber sleeve, and the external semiconductive layer is insulated from both the stress-relief cones.

2. The cold-shrinkable type rubber sleeve according to claim 1, wherein the external semiconductive layer covers the stress-relief cones through the reinforced insulation layer.

3. The cold-shrinkable type rubber sleeve according to claim 1, wherein the external semiconductive layer is substantially cylindrical.

4. The cold-shrinkable type rubber sleeve according to claim 1, wherein a thickness of the external semiconductive layer is substantially uniform.

5. A cold-shrinkable type rubber sleeve that is tube shaped, comprising:
an internal semiconductive layer that includes an elastic material and a semiconductive material;
a reinforced insulation layer that is formed around the internal semiconductive layer to reinforce the internal semiconductive layer;
an external semiconductive layer that includes an elastic material and a semiconductive material, and is formed around the reinforced insulation layer;
two stress-relief cones, wherein one stress-relief cone is formed at each end of the cold-shrinkable type rubber sleeve; and
two edge-cut sections, each edge-cut section is formed near each of the stress-relief cones by edge-cutting the external semiconductive layer in a direction of a length of the cold-shrinkable type rubber sleeve.

6. The cold-shrinkable type rubber sleeve according to claim 5, wherein the external semiconductive layer covers the stress-relief cones through the reinforced insulation layer.

7. The cold-shrinkable type rubber sleeve according to claim 5, wherein the external semiconductive layer is substantially cylindrical.

8. The cold-shrinkable type rubber sleeve according to claim 5, wherein a thickness of the external semiconductive layer is substantially uniform.

9. A method of manufacturing a cold-shrinkable type rubber sleeve, comprising:
forming a tube of an internal semiconductive layer with an elastic material and a semiconductive material;
forming a reinforced insulation layer around the internal semiconductive layer to reinforce the internal semiconductive layer;
forming an external semiconductive layer around the reinforced insulation layer with an elastic material and a semiconductive material;
forming a stress-relief cone at each end of the cold-shrinkable type rubber sleeve; and
insulating the external semiconductive layer from both the stress-relief cones.
